(19) United States
(12) Patent Application Publication
(10) Pub. No.: US 2006/0208970 A1
(43) Pub. Date: Sep. 21, 2006

(54) Plasma display apparatus and driving method thereof

(75) Inventor: Ji-seung Yoo, Yongin-si (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/369,758

(22) Filed: Mar. 8, 2006

(30) Foreign Application Priority Data
Mar. 8, 2005 (KR) 10-2005-0019381

(51) Int. Cl. G09G 3/28

(52) U.S. Cl. 345/67

(57) ABSTRACT

The present invention relates to a plasma display apparatus and driving method thereof. To prevent the occurrence of EMI when a plasma display panel is driven, directions of driving pulses supplied to a plurality of the same kinds of electrodes are set to be different each other.

### CROSS-REFERENCES TO RELATED APPLICATIONS

This Nonprovisional application claims priority under 35 U.S. C. § 119(a) on Patent Application No. 10-2005-0019381 filed in Korea on Mar. 8, 2005 the entire contents of which are hereby incorporated by reference.

### BACKGROUND OF THE INVENTION

1. Field of the Invention

The present invention relates to a plasma display apparatus and driving method thereof.

2. Background of the Related Art

Recently, a variety of flat display apparatuses capable of reducing the weight and volume (i.e., the disadvantages of the cathode ray tube) have been developed. The flat display apparatuses may include a Liquid Crystal Display (LCD), a Field Emission Display (FED), a Plasma Display Panel (PDP), an Electro-Luminescence (EL) display device and so on. Of them, the PDP is a display device employing gas discharge and is advantageous in that it can be easily made large.

In the PDP, one frame consists of a plurality of sub-fields. Each sub-field is driven with it being divided into a reset period for initializing discharge cells of the plasma display panel, an address period for selecting discharge cells and a sustain period for sustaining the discharge of selected discharge cells.

FIG. 1 is a schematic block diagram of a plasma display apparatus in the related art.

Referring to FIG. 1, the related art plasma display apparatus has a PDP 111 on which images are displayed, a data driver 101 for supplying data to address electrodes X1 to Xm, a scan driver 103 for driving scan electrodes Y1 to Yn, a sustain driver 105 for driving sustain electrodes Z, a timing controller 107 for controlling the respective drivers 101, 103 and 105, and a driving voltage generator 109 for supplying necessary driving voltages to the respective drivers 101, 103 and 105.

In the PDP 111, discharge cells 113 are formed at the intersections of the scan electrodes Y1 to Yn, the sustain electrodes Z and the address electrodes X1 to Xm.

The data driver 101 samples and latches data and supplies a data voltage (Va) of the data to the address electrodes X1 to Xm, in response to a timing control signal (Cx) from the timing controller 107.

The scan driver 103 supplies initialization pulses to the scan electrodes Y1 to Yn in response to a timing control signal (Cy) from the timing controller 107 during the reset period. The scan driver 103 sequentially supplies scan pulses to the scan electrodes Y1 to Yn while supplying a scan reference voltage (Vsc) to the scan electrodes Y1 to Yn during the address period. Furthermore, the scan driver 103 supplies Y sustain pulses to the scan electrodes Y1 to Yn during the sustain period.

The sustain driver 105 supplies a positive (+) sustain voltage (Vs) to the sustain electrodes Z during the set-down period and the address period in response to the timing control signal (Cz) from the timing controller 12, and then supplies a Z sustain pulse to the sustain electrodes Z while operating alternately with the scan driver 8 during the sustain period.

The timing controller 107 receives vertical/horizontal sync signals and clock signals and generates the timing control signals (Cx, Cy, Cz) necessary for the respective drivers 101, 103 and 105. The timing controller 107 supplies the timing control signals (Cx, Cy, Cz) to corresponding drivers 101, 103 and 105, thereby controlling the respective drivers 101, 103 and 105. The data control signal (Cx) includes a sampling clock for sampling data, a latch control signal, and a switching control signal for controlling an on/off time of an energy recovery circuit and a driving switch element. The scan control signal (Cy) includes a switching control signal for controlling an on/off time of an energy recovery circuit and a driving switch element within the scan driver 103. The sustain control signal (Cz) includes a switching control signal for controlling an on/off time of an energy recovery circuit and a driving switch element within the sustain driver 105.

The driving voltage generator 109 generates a set-up voltage (Vsetup), a negative (−) scan voltage (Vy), a scan reference voltage (Vsc), a positive (+) sustain voltage (Vs), a data voltage (Va) and the like and supplies them to the data driver 101, the scan driver 103 and the sustain driver 105.

FIG. 2 is a view illustrating the flow of current according to a voltage applied to the PDP in the plasma display apparatus shown in FIG. 1.

Referring to FIG. 2, if the scan driver 103 supplies the driving pulses to the scan electrodes Y1 to Yn during the sustain period, the current (C) flows from the scan electrodes Y1 to Yn to the sustain electrodes Z. The current (C) causes electromagnetic fields (M, E) to occur within the PDP 111. To the contrary, if the sustain driver 105 supplies the sustain electrodes Z with the driving pulse, the current flows from the sustain electrodes Z to the scan electrodes Y1 to Yn.

If the PDP is driven as described above, electromagnetic fields, which are generated by the current flowing from electrodes to which the driving pulse is applied to electrodes to which the driving pulse is not applied, are not offset each other, but radiated in the same direction as that along which the current flows. Accordingly, the related art plasma display apparatus is problematic in that a great amount of Electro-Magnetic Interference (EMI) is generated in the front direction of the PDP 111.

### SUMMARY OF THE INVENTION

Accordingly, an object of the present invention is to solve at least the problems and disadvantages of the background art.

It is an object of the present invention to provide a plasma display apparatus and driving method thereof, wherein the reliability can be improved by reducing EMI generated when a PDP is driven.

A plasma display apparatus according to a first embodiment of the present invention comprises a PDP comprising a plurality of scan electrodes and a plurality of sustain electrodes, a scan driver for setting directions of driving pulses supplied to at least one pair of scan electrodes of the plurality of scan electrodes to be different from each other, and a sustain driver for setting directions of driving pulses supplied to at least one pair of sustain electrodes of the plurality of sustain electrodes to be different from each other.

A plasma display apparatus according to a second embodiment of the present invention comprises a PDP comprising a plurality of scan electrodes and a plurality of sustain electrodes, a first scan driver that supplies a driving pulse to first electrode groups of the plurality of scan electrodes, a second scan driver that supplies a driving pulse, which has a different direction from that of the driving pulse supplied to the first electrode groups, to the remaining second electrode groups other than the first electrode groups, of the plurality of scan electrodes, a first sustain driver that supplies a driving pulse to first electrode groups of the plurality of sustain electrodes, and a second sustain driver that supplies a driving pulse, which has a different direction from that of the driving pulse supplied to the first electrode groups, to the remaining second electrode groups other than the first electrode group, of the plurality of sustain electrodes.

A method of driving a plasma display apparatus according to a third embodiment of the present invention comprises the steps of while supplying a driving pulse to a first scan electrode group of the plurality of scan electrodes, supplying a driving pulse, which has a direction different from that of the driving pulse supplied to the first scan electrode group, to a second scan electrode group of the plurality of scan electrodes, and while supplying a driving pulse to a first sustain electrode group of the plurality of sustain electrodes, supplying a driving pulse, which has a direction different from that of the driving pulse supplied to the first sustain electrode group, to a second sustain electrode group of the plurality of sustain electrodes.

The present invention can reduce EMI generated when a PDP is driven by controlling the direction of driving pulses supplied to the electrodes of the PDP.

### BRIEF DESCRIPTION OF THE DRAWINGS

The invention will be described in detail with reference to the following drawings in which like numerals refer to like elements.

FIG. 1 is a schematic block diagram of a plasma display apparatus in the related art;

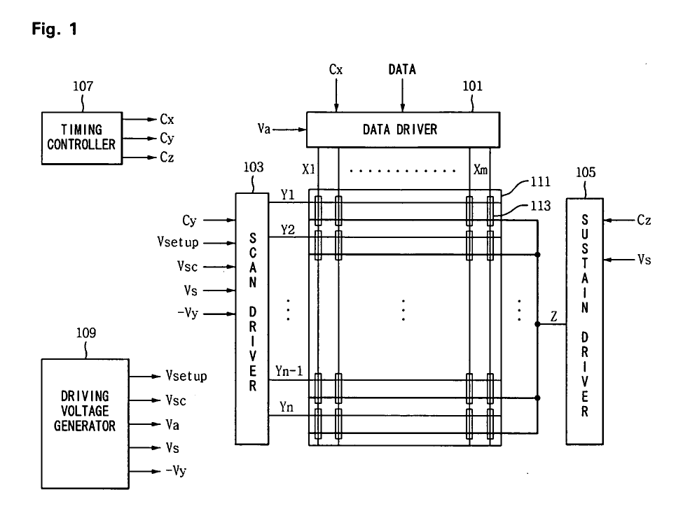

FIG. 2 is a view illustrating the flow of current according to a voltage applied to the PDP in the plasma display apparatus shown in FIG. 1;

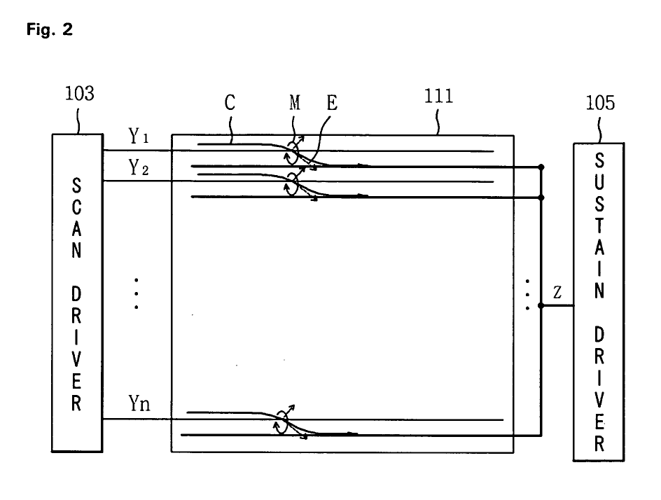

FIG. 3 is a schematic block diagram of a plasma display apparatus according to a first embodiment of the present invention;

FIG. 4 shows an arrangement structure of electrode groups formed in the PDP of FIG. 3;

FIG. 5 is a schematic block diagram of another plasma display apparatus according to a first embodiment of the present invention;

FIG. 6 shows a driving waveform applied to the PDP according to the first embodiment of the present invention;

FIG. 7 is a schematic block diagram of a plasma display apparatus according to a second embodiment of the present invention;

FIG. 8 is a schematic block diagram of another plasma display apparatus according to a second embodiment of the present invention; and

FIG. 9 illustrates the directions of driving pulses supplied to the scan electrodes and the sustain electrodes of the PDP in the first and second embodiments of the present invention.

### DETAILED DESCRIPTION OF THE PREFERRED EMBODIMENT

Specific embodiments of the present invention will be described in a more detailed manner with reference to the annexed drawings.

(First Embodiment)

A plasma display apparatus according to a first embodiment of the present invention comprises a PDP comprising a plurality of scan electrodes and a plurality of sustain electrodes, a scan driver for setting directions of driving pulses supplied to at least one pair of scan electrodes of the plurality of scan electrodes to be different from each other, and a sustain driver for setting directions of driving pulses supplied to at least one pair of sustain electrodes of the plurality of sustain electrodes to be different from each other.

The pair of scan electrodes and the pair of sustain electrodes are adjacent to each other among the same electrodes. Each of the pair of scan electrodes and the pair of sustain electrodes that are adjacent to each other among the same electrodes may be at least one of the entire scan electrodes and the entire sustain electrodes formed in the PDP.

The pair of scan electrodes and the pair of sustain electrodes may not be adjacent to each other among the same electrodes.

The driving pulses may be all kinds of driving pulses supplied to electrodes formed in the PDP in each period when the PDP is driven with one sub-field being divided into a reset period, an address period and a sustain period, but may also be sustain pulses supplied to the plurality of scan electrodes and the plurality of the sustain electrodes in the sustain period of one sub-field.

A first embodiment of the present invention will be described below with reference to the accompanying drawings.

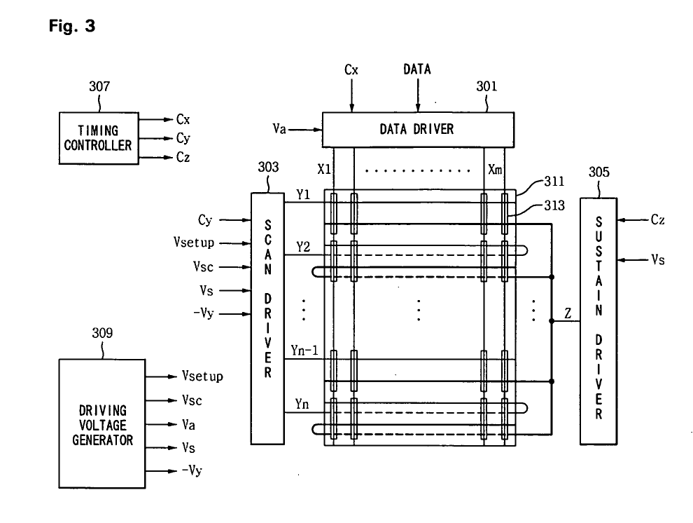

FIG. 3 is a schematic block diagram of a plasma display apparatus according to a first embodiment of the present invention.

Referring to FIG. 3, the plasma display apparatus according to a first embodiment of the present invention comprises a PDP 311 on which images are displayed, a data driver 301 for supplying data to a plurality of address electrodes X1 to Xm, a scan driver 303 for supplying driving pulses, which do not have the same direction, to a plurality of scan electrodes Y1 to Yn, a sustain driver 305 for supplying driving pulses, which do not have the same direction, to a plurality of sustain electrodes Z in the same manner as the scan driver 303, a timing controller 307 for controlling the respective drivers 301, 303 and 305, and a driving voltage generator 309 for supplying driving voltages necessary to drive the respective drives 301, 303 and 305.

The PDP 311 includes an upper substrate (not shown) in which the plurality of scan electrodes Y1 to Yn and the plurality of sustain electrodes Z are formed, and a lower substrate (not shown) in which the plurality of address electrodes X1 to Xm are formed. The upper substrate and the lower substrate are coalesced at predetermined distances. The PDP 311 has discharge cells 313 formed at the intersections of the plurality of scan electrodes Y1 to Yn, the plurality of sustain electrodes Z and the plurality of address electrodes X1 to Xm. The discharge cells 313 generate light that implements an image according to the driving pulses supplied from the data driver 301, the scan driver 303 and the sustain driver 305.

The data driver 301 samples and latches data and supplies a data voltage (Va) of the data to the address electrodes X1 to Xm, in response to a timing control signal (Cx) from the timing controller 307. The data voltage (Va) supplied to each discharge cell 313 through the address electrodes X1 to Xm has the same amount regardless of phosphors coated within the discharge cells 313.

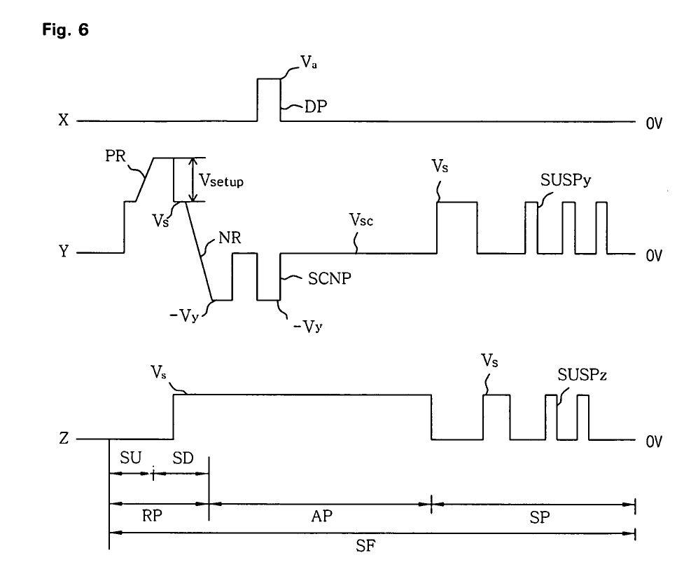

As shown in FIG. 6, the scan driver 303 supplies initialization pulses, such as a ramp-up pulse (PR) and a ramp-down pulse (NR), to the scan electrodes Y1 to Yn during the reset period (RP) in response to a timing control signal (Cy) from the timing controller 307. The scan driver 303 then sequentially supplies scan pulses (SCNP) to the scan electrodes Y1 to Yn while supplying a scan reference voltage (Vsc) to the scan electrodes Y1 to Yn during the address period (AP). The scan driver 303 also supplies Y sustain pulses (SUSPy) to the scan electrodes Y1 to Yn during the sustain period (SP).

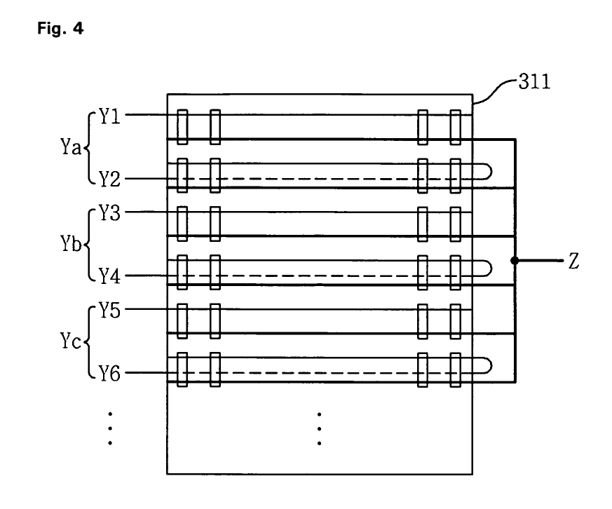

Furthermore, the scan driver 303 divides the entire scan electrodes Y1 to Yn into a plurality of scan electrode groups (Ya, Yb, Yc, . . . ) respectively comprising a plurality of scan electrodes, as shown in FIG. 4, when supplying the driving pulses such as the initialization pulses (PR, NR), the scan pulse (SCNP) and the sustain pulse (SP) to the scan electrodes Y1 to Yn. The scan driver 303 then sets the directions of the driving pulses supplied to the scan electrodes included in each scan electrode group to be different from each other.

It has been described above that the directions of the driving pulses supplied to a plurality of scan electrodes included in each of the scan electrode groups (Ya, Yb, Yc, . . . ) are different from each other. It is, however, to be understood that the directions of driving pulses supplied to a plurality of scan electrodes included in only one of the scan electrode groups (Ya, Yb, Yc, . . . ) may be different from each other.

In addition, the number of the scan electrodes included in the plurality of scan electrode groups may be preferably different, but may be the same. More preferably, the scan electrodes included in the scan electrode groups may form pairs. This is for further facilitating the process of forming the electrodes in the PDP.

Furthermore, the pairs of the scan electrodes included in the scan electrode groups are formed in the PDP so that they are not adjacent to one another.

The pairs of the scan electrodes included in each of the entire scan electrode groups are not adjacent to each other. In this case, what the pairs of the scan electrodes are not adjacent to each other means an arrangement structure of electrodes formed in the PDP. In other words, it means that different electrodes (for example, the sustain electrodes) are formed between two scan electrodes formed in the PDP.

Regarding the arrangement structure of electrodes formed in the PDP, only the scan electrode group having the pair of the scan electrodes has been described above. It is, however, to be noted that the present invention may be applied to a scan electrode group comprising three or more scan electrodes.

Meanwhile, in the plasma display apparatus according to a first embodiment of the present invention, it has been described that the driving pulses generated from the scan driver 303 are the initialization pulses (PR, NR) supplied to the scan electrodes Y during the reset period and the scan pulse (SCNP) supplied to the scan electrodes Y during the address period as shown in FIG. 6. However, the driving pulses generated from the scan driver 303 may be a sustain pulse (SUSPy) supplied to the scan electrodes Y during the sustain period.

This is because the greatest amount of EMI can be prohibited if the directions of the sustain pulses supplied from the scan driver 303 to the scan electrode groups comprising the plurality of scan electrodes during the sustain period are set to be different from each other when the PDP is driven.

The sustain driver 305 supplies a bias waveform having a positive (+) voltage (for example, the sustain voltage (Vs)) to the sustain electrodes Z during the set-down period (SD) and the address period (AP) and then supplies a Z sustain pulse (SUSPz) to the sustain electrodes Z while operating alternately with the scan driver 303 during the sustain period (SP), in response to a timing control signal (Cz) from the timing controller 307 as shown in FIG. 6. Though not shown in the drawing, the bias waveform supplied to the sustain electrodes Z may be supplied during the address period (AP) not including the set-down period.

Furthermore, when supplying the bias waveform and the driving pulse such as the sustain pulse to the sustain electrodes Z, the sustain driver 305 divides the sustain electrodes Z into a plurality of sustain electrode groups, each comprising a plurality of sustain electrodes, and sets the directions of driving pulses supplied to the sustain electrodes included in each sustain electrode group to be different from each other.

At this time, the number of the sustain electrode groups in which the directions of the driving pulses are different, the number of the sustain electrodes included in each sustain electrode group, an arrangement structure of the sustain electrodes formed in the PDP, and the type of the driving pulses supplied to the sustain electrodes are the same as those that have been described with reference to the scan drive. Accordingly, description thereof will be omitted.

The timing controller 307 receives vertical/horizontal sync signals and a clock signal and generates the timing control signals (Cx, Cy, Cz) necessary for the respective drivers 301, 303 and 305. The timing controller 307 supplies the timing control signals (Cx, Cy, Cz) to corresponding drivers 301, 303 and 305, thereby controlling the respective drivers 301, 303 and 305. The data control signal (Cx) includes a sampling clock for sampling data, a latch control signal, and a switching control signal for controlling an on/off time of an energy recovery circuit and a driving switch element. The scan control signal (Cy) includes a switching control signal for controlling an on/off time of an energy recovery circuit and a driving switch element within the scan driver 303. The sustain control signal (Cz) includes a switching control signal for controlling an on/off time of an energy recovery circuit and a driving switch element within the sustain driver 305.

The driving voltage generator 309 generates a set-up voltage (Vsetup), a negative (−) scan voltage (Vy), a scan reference voltage (Vsc), a positive (+) sustain voltage (Vs), a data voltage (Va) and so on and supplies them to the data driver 301, the scan driver 303 and the sustain driver 305.

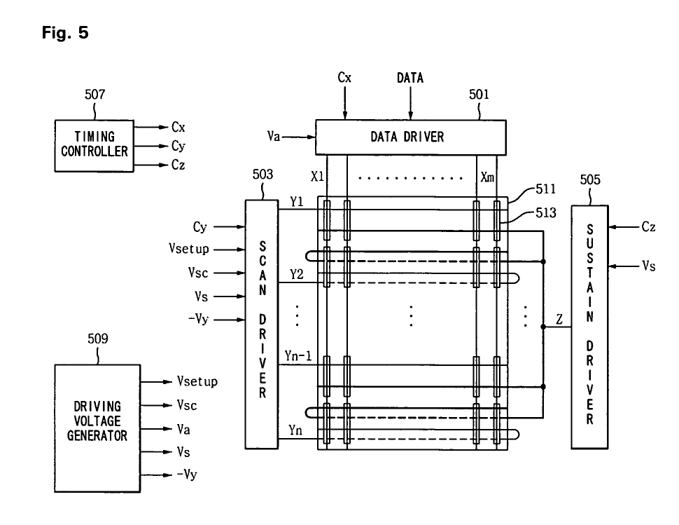

FIG. 5 is a schematic block diagram of another plasma display apparatus according to a first embodiment of the present invention.

Referring to FIG. 5, another plasma display apparatus according to a first embodiment of the present invention has the same construction as that of the plasma display apparatus according to a first embodiment of the present invention, and detailed description thereof will be omitted accordingly.

Furthermore, in another plasma display apparatus according to a first embodiment of the present invention, the entire scan electrodes Y1 to Yn are divided into a plurality of scan electrode groups, respectively comprising a plurality of scan electrodes, and the entire sustain electrodes Z are divided into a plurality of sustain electrode groups, respectively comprising a plurality of scan electrodes. The directions of driving pulses supplied to the scan electrodes included in each scan electrode group and the sustain electrodes included in each sustain electrode group are set to be different from each other. In other words, the directions of the driving pulses applied to the same electrodes included in the same electrode group are set to be different from each other.

The number of sustain electrode groups and scan electrode groups in which driving pulses are applied in different directions, the number of sustain electrodes included in each sustain electrode group and the number of scan electrodes included in each scan electrode group, and the type of driving pulses supplied to the sustain electrodes and the scan electrodes are the same as those that have been described with reference to the plasma display apparatus according to the first embodiment of the present invention, and detailed description thereof will be omitted accordingly.

In an arrangement structure of the scan electrodes belonging to the scan electrode groups and the sustain electrodes belonging to the sustain electrode groups, however, the same scan and sustain electrodes are formed adjacent to the PDP unlike the plasma display apparatus according to the first embodiment of the present invention.

Though all the scan electrode groups formed in the PDP 511 can be formed adjacent to each other, only a pair of scan electrodes included in at least one of the scan electrode groups formed in the PDP can be adjacent to each other.

The sustain electrode groups formed in the PDP also has the same electrode arrangement structure as that of the scan electrode groups.

FIG. 6 shows a driving waveform applied to the PDP according to the first embodiment of the present invention.

Before reference is made to FIG. 6, when the PDP according to the present invention is driven, one frame consists of a plurality of sub-fields. Each sub-field (SF) is divided into a reset period (RP) for initializing discharge cells of the entire screen, an address period (AP) for selecting discharge cells and a sustain period (SP) for sustaining the discharge of the selected discharge cells, as shown in FIG. 6.

In a set-up period (SU) of the reset period (RP), a ramp-up pulse (PR), which rises from a sustain voltage (Vs) to a peak voltage (Vs+Vsetup) at a predetermined slope, to the entire scan electrodes Y at the same time. The ramp-up pulse (PR) causes a weak discharge (a set-up discharge) to be generated within the cells of the entire screen, so that wall charges are formed within the cells.

In a set-down period (SD) of the reset period (RP), a ramp-down pulse (NR), which falls from a positive (+) sustain voltage (Vs) lower than the peak voltage (Vs+Vsetup) of the ramp-up pulse (PR) to a negative (−) scan voltage (Vy), is supplied to the scan electrodes Y at the same time. The ramp-down pulse (NR) causes a weak erase discharge to be generated within the cells. The weak erase discharge causes wall charges generated by the set-up discharge and unnecessary charges of spatial charges to be erased and causes wall charges necessary for address discharge to uniformly remain within the cells of the entire screen.

In the address period (AP), while a negative (−) scan pulse (SCNP) is sequentially applied to the scan electrodes Y, a positive (+) data pulse (DP) is supplied to the address electrodes X. As a voltage difference between the scan pulse (SCNP) and the data pulse (DP) and a wall voltage generated by the reset period (RP) are added, address discharge is generated within cells to which the data pulse (DP) is supplied. Wall charges are generated within cells generated by the address discharge.

Meanwhile, during the set-down period (SD) and the address period (AP), a positive (+) bias waveform is supplied to the sustain electrodes Z.

In the sustain period (SP), sustain pulses (SUSPy, SUSPz) are alternately supplied to the scan electrodes Y and the sustain electrodes Z. As a result, sustain discharge i s generated in surface discharge form between the scan electrodes Y and the sustain electrode Z of the cells selected by the address discharge whenever the sustain pulses (SUSPy, SUSPz) are supplied to the scan electrodes Y and the sustain electrode Z as the wall voltage within the cells and the sustain pulses (SUSPy, SUSPz) are added.

The application directions of the driving pulses supplied to the respective electrodes of the PDP, such as the ramp pulse, the scan pulse and the sustain pulse, are different in at least on electrode group as mentioned above.

(Second Embodiment)

A plasma display apparatus according to a second embodiment of the present invention comprises a PDP comprising a plurality of scan electrodes and a plurality of sustain electrodes, a first scan driver that supplies a driving pulse to first electrode groups of the plurality of scan electrodes, a second scan driver that supplies a driving pulse, which has a different direction from that of the driving pulse supplied to the first electrode groups, to the remaining second electrode groups other than the first electrode groups, of the plurality of scan electrodes, a first sustain driver that supplies a driving pulse to first electrode groups of the plurality of sustain electrodes, and a second sustain driver that supplies a driving pulse, which has a different direction from that of the driving pulse supplied to the first electrode groups, to the remaining second electrode groups other than the first electrode group, of the plurality of sustain electrodes.

The driving pulses may be all kinds of driving pulses supplied to electrodes formed in the PDP in each period when the PDP is driven with one sub-field being divided into a reset period, an address period and a sustain period, but may also be sustain pulses supplied to the plurality of scan electrodes and the plurality of the sustain electrodes in the sustain period of one sub-field.

The number of electrodes belonging to the first electrode group and the number of electrodes belonging to the second electrode group may be different from each other or the same.

The first electrode groups of the plurality of scan electrodes may be odd-numbered scan electrodes of the plurality o f scan electrodes and the first electrode groups of the plurality of sustain electrodes may be odd-numbered sustain electrodes of the plurality of scan electrodes. Furthermore, the second electrode groups of the plurality of scan electrodes may be even-numbered scan electrodes of the plurality of scan electrodes and the second electrode groups of the plurality of sustain electrodes may be even-numbered sustain electrodes of the plurality of scan electrodes.

Another plasma display apparatus according to a second embodiment of the present invention comprises a PDP comprising a plurality of scan electrodes and a plurality of sustain electrodes, a first scan driver formed on a longitudinal side of the PDP, for supplying a driving pulse to a first scan electrode group of the plurality of scan electrodes, a first sustain driver formed adjacent to the first scan driver, for supplying a driving pulse to a first sustain electrode group of the plurality of sustain electrodes, a second scan driver on a longitudinal side of the PDP, for supplying a driving pulse, which has a direction different from that of the driving pulse supplied to the first scan electrode group, to a second scan electrode group of the plurality of scan electrodes, and a second sustain driver formed adjacent to the second scan driver, for supplying a driving pulse, which has a direction different from that of the driving pulse supplied to the first sustain electrode group, to a second sustain electrode group of the plurality of sustain electrodes.

The first scan driver and the first sustain driver may be formed on an opposite side to the second scan driver and the second sustain driver on the basis of a central longitudinal axis of the PDP.

The driving pulses may be all kinds of driving pulses supplied to electrodes formed in the PDP in each period when the PDP is driven with one sub-field being divided into a reset period, an address period and a sustain period, but may also be sustain pulses supplied to the plurality of scan electrodes and the plurality of the sustain electrodes in the sustain period of one sub-field.

Another plasma display apparatus according to a second embodiment of the present invention comprises a PDP comprising a plurality of scan electrodes and a plurality of sustain electrodes, a first scan driver formed on a longitudinal side of the PDP, for supplying a driving pulse to odd-numbered scan electrodes of the plurality of scan electrodes, a first sustain driver formed adjacent to the first scan driver, for supplying a driving pulse to odd-numbered sustain electrodes of the plurality of sustain electrodes, a second scan driver formed on a longitudinal side of the PDP, for supplying a driving pulse, which has a direction different from that of the driving pulse supplied to the odd-numbered scan electrodes, to even-numbered scan electrodes of the plurality of scan electrodes, and a second sustain driver formed adjacent to the second scan driver, for supplying a driving pulse, which has a direction different from that of the driving pulse supplied to the odd-numbered sustain electrodes, to even-numbered sustain electrodes of the plurality of sustain electrodes.

The first scan driver and the first sustain driver are formed on an opposite side to the second scan driver and the second sustain driver on the basis of a central longitudinal axis of the PDP.

A method of driving a plasma display apparatus according to a second embodiment of the present invention comprises the steps of while supplying a driving pulse to a first scan electrode group of the plurality of scan electrodes, supplying a driving pulse, which has a direction different from that of the driving pulse supplied to the first scan electrode group, to a second scan electrode group of the plurality of scan electrodes, and while supplying a driving pulse to a first sustain electrode group of the plurality of sustain electrodes, supplying a driving pulse, which has a direction different from that of the driving pulse supplied to the first sustain electrode group, to a second sustain electrode group of the plurality of sustain electrodes.

Hereinafter, a second embodiment of the present invention will be described with reference to the accompanying drawings.

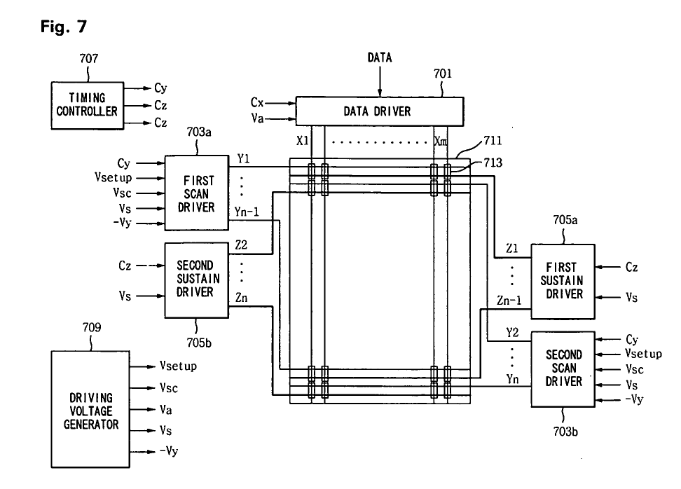

FIG. 7 is a schematic block diagram of a plasma display apparatus according to a second embodiment of the present invention.

Referring to FIG. 7, the plasma display apparatus according to a second embodiment of the present invention comprises a PDP 711 on which images are displayed, a data driver 701 for supplying data to a plurality of address electrodes X1 to Xm, a first scan driver 703a for supplying a driving pulse to a first electrode group of the plurality of scan electrodes Y1 to Yn, a second scan driver 703bfor supplying a driving pulse, which has a direction different from that of the driving pulse supplied to the first electrode group, to the remaining second electrode groups other than the first electrode group, of the plurality of scan electrodes, a first sustain driver 705a for supplying a driving pulse to a first electrode group of the plurality of sustain electrodes, a second sustain driver 705b that supplies a driving pulse, which has a different direction from that of the driving pulse supplied to the first electrode group, to the remaining second electrode groups other than the first electrode group, of the plurality of sustain electrodes, a timing controller 707 for controlling the respective drivers 701, 703a, 703b, 705a and 705b, and a driving voltage generator 709 for supplying driving voltages necessary to drive the respective drivers 701, 703a, 703b, 705a and 705b.

The PDP 711 and the data driver 701 are the same as the PDP 311 and the data driver 301, respectively, of the first embodiment of the present invention, and detailed description thereof will be omitted accordingly.

The first scan driver 703a supplies the initialization pulses such as the ramp-up pulse (PR) and the ramp-down pulse (NR) to first scan electrode groups (Y1, Y3, Y5, . . . ) of two electrode groups in which the entire scan electrodes Y1 to Yn are grouped during the reset period (RP) in response to the timing control signal (Cy) from the timing controller 707 in the same manner as FIG. 6. The first scan driver 703a then sequentially supplies the scan pulse (SCNP) to the scan electrodes Y1 to Yn while supplying the scan reference voltage (Vsc) to the first scan electrode groups (Y1, Y3, Y5, . . . ) during the address period (AP). The first scan driver 703a also supplies the Y sustain pulse (SUSPy) to the first scan electrode groups (Y1, Y3, Y5, . . . ) during the sustain period (SP).

The second scan driver 703b supplies the initialization pulses such as the ramp-up pulse (PR) and the ramp-down pulse (NR) to second scan electrode groups (Y2, Y4, Y6 . . . ) of two electrode groups in which the entire scan electrodes Y1 to Yn are grouped during the reset period (RP) in response to the timing control signal (Cy) from the timing controller 707 as in FIG. 6. The second scan driver 703b then sequentially supplies the scan pulse (SCNP) to the scan electrodes Y1 to Yn while supplying the scan reference voltage (Vsc) to the second scan electrode groups (Y2, Y4, Y6, . . . ) during the address period (AP). The second scan driver 703b also supplies the Y sustain pulse (SUSPy) to the second scan electrode groups (Y2, Y4, Y6, . . . ) during the sustain period (SP).

The first scan driver 703a and the second scan driver 703b set the driving pulses, which are supplied to the first scan electrode groups (Y1, Y3, Y5, . . . ) and the second scan electrode groups (Y2, Y4, Y6, . . . ), to have different directions when supplying the driving pulses such as the initialization pulses, the scan pulse and the sustain pulse to the first scan electrode groups (Y1, Y3, Y5, . . . ) and the second scan electrode groups (Y2, Y4, Y6, . . . ), respectively.

At this time, the number of scan electrodes belonging to the first scan electrode groups (Y1, Y3, Y5, . . . ) and the number of scan electrodes belonging to the second scan electrode groups (Y2, Y4, Y6, . . . ) may be the same or different from each other.

Furthermore, if the first scan electrode groups are the odd-numbered scan electrodes (Y1, Y3, Y5, . . . ) of the entire scan electrodes arranged in the PDP 711, the second scan electrode groups may be the even-numbered sustain electrodes (Y2, Y4, Y6 . . . ) of the entire scan electrodes and vice versa is also possible.

In this case, the PDP is formed so that the scan electrodes included in the first scan electrode groups and the scan electrodes included in the second scan electrode groups are not adjacent to each other.

Meanwhile, in the plasma display apparatus according to a second embodiment of the present invention, it has been described that the driving pulses generated by the first scan driver 703a and the second scan driver 703b are the initialization pulses (PR, NR) supplied to the scan electrodes Y during the reset period (RP) and the scan pulse (SCNP) supplied to the scan electrodes Y during the address period (AP) as in FIG. 6. However, the driving pulses generated by the first scan driver 703a and the second scan driver 703b may be the sustain pulses (SUSPy, SUSPz) supplied to the scan electrodes Y during the sustain period (SP).

This is the same as that of the first embodiment of the present invention, and detailed description thereof will be omitted accordingly.

The first sustain driver 705a supplies a bias waveform having a positive (+) voltage (for example, the sustain voltage (Vs)) to first sustain electrode groups (Z1, Z3, Z5, . . . ) of two electrode groups in which the entire sustain electrodes Z are grouped during the set-down period (SD) and the address period (AP) in response to the timing control signal (Cz) from the timing controller 707. The first sustain driver 705a then supplies the Z sustain pulse (SUSPz) to the first sustain electrode groups (Z1, Z3, Z5, . . . ) while operating alternately with the first scan driver 703a during the sustain period (SP). Though not shown in the drawing, the bias waveform supplied to the sustain electrodes Z may be supplied during the address period not including the set-down period.

The second sustain driver 705b supplies a bias waveform having a positive (+) voltage (for example, the sustain voltage (Vs)) to second sustain electrode groups (Z2, Z4, Z6, . . . ) of the two electrode groups in which the entire sustain electrodes Z are grouped during the set-down period (SD) and the address period (AP) in response to the timing control signal (Cz) from the timing controller 707. The second sustain driver 705b then supplies the Z sustain pulse (SUSPz) to the second sustain electrode groups (Z2, Z4, Z6, . . . ) while operating alternately with the second scan driver 703b during the sustain period (SP). Though not shown in FIG. 7, the bias waveform supplied to the sustain electrodes Z may be supplied during the address period not including the set-down period.

The directions of the driving pulses by the first sustain driver 705a and the second sustain driver 705b, the number of the sustain electrodes belonging to the first sustain electrode group and the second sustain electrode group, and the structure of the sustain electrode groups formed in the PDP are the same as those in the first scan driver and the second scan driver, and detailed description thereof will be omitted accordingly.

Meanwhile, the first scan driver 703a, the first sustain driver 705a, the second scan driver 703b and the second sustain driver 705b of the plasma display apparatus according to a second embodiment of the present invention may be placed anywhere on the PDP. However, the first scan driver 703a and the second sustain driver 705b may be formed on the same longitudinal side of the PDP and the second scan driver 703b and the first sustain driver 705a may be formed on an opposite longitudinal side to the PDP.

The first scan driver 703a and the second sustain driver 705b may be disposed with them being inclined toward any one side on the basis of the central longitudinal axis (not shown) of the PDP and may be disposed at the same distance from the central longitudinal axis of the PDP. In addition, the second scan driver 703b and the first sustain driver 705a may be disposed at the same distance from the central longitudinal axis of the PDP as described above.

The timing controller 707 and the driving voltage generator 709 have the same construction as those according to the first embodiment of the present invention, and detailed description thereof will be omitted accordingly.

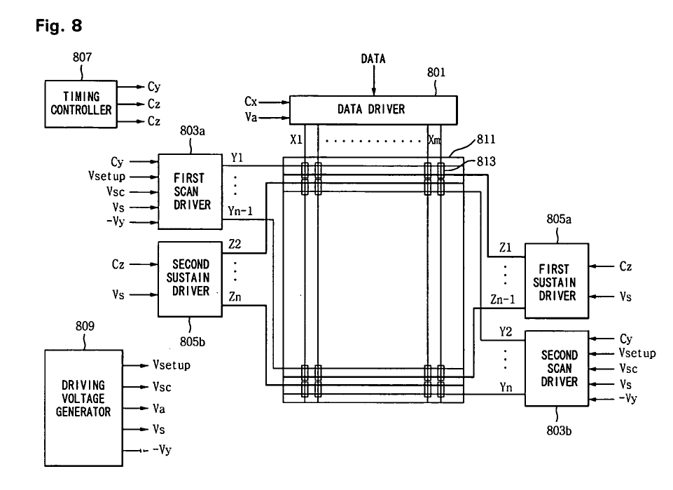

FIG. 8 is a schematic block diagram of another plasma display apparatus according to a second embodiment of the present invention.

Referring to FIG. 8, another plasma display apparatus according to a second embodiment of the present invention has the same construction as that of the plasma display apparatus according to a second embodiment of the present invention, and detailed description thereof will be omitted accordingly.

In another plasma display apparatus according to a second embodiment of the present invention, a first scan driver 803a and a second scan driver 803b divide the entire scan electrodes Y1 to Yn into first scan electrode groups (Y1, Y3, Y5, . . . ) and second scan electrode groups (Y2, Y4, Y6, . . . ) respectively comprising a plurality of scan electrodes, and set the direction of a driving pulse supplied to the first scan electrode groups to be different from that of a driving pulse supplied to the second scan electrode groups.

A first sustain driver 805a and a second sustain driver 805b also set the direction of a driving pulse supplied to first sustain electrode groups (Z1, Z3, Z5, . . . ) to be different from that of a driving pulse supplied to second sustain electrode groups (Z2, Z4, Z6, . . . ).

The number of electrodes belonging to the first scan electrode groups, the second scan electrode groups, the first sustain electrode groups and the second sustain electrode groups to which the driving pulses are supplied in different directions, and the type of the driving pulse supplied to each electrode group are the same as those of the plasma display apparatus according to a second embodiment of the present invention, and detailed description thereof will be omitted accordingly.

In the arrangement structure, however, scan electrodes and sustain electrodes belonging to the first scan electrode groups, the second scan electrode groups, the first sustain electrode groups and the second sustain electrode groups are adjacent to one another among the same electrodes unlike the plasma display apparatus according to a second embodiment of the present invention.

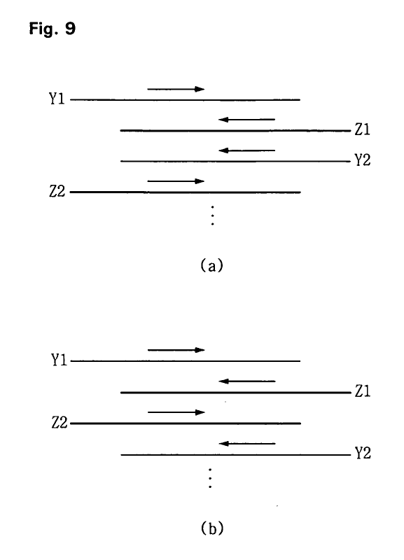

FIG. 9 illustrates the directions of driving pulses supplied to the scan electrodes and the sustain electrodes of the PDP in the first and second embodiments of the present invention.

FIG. 9(a) shows an arrangement structure in which the same electrodes are not adjacent to each other, of the arrangement structure of the electrodes formed in the PDP. FIG. 9(b) shows an arrangement structure in which the same electrodes are adjacent to each other, of the arrangement structure of the electrodes formed in the PDP. As shown in FIG. 9, the current directions (arrow directions) of the driving pulses are different from each other in the same electrodes.

If the current directions of the driving pulses are different from each other in the same electrodes, EMI generated when the PDP is driven can be reduced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus comprising:
a plasma display panel (PDP) comprising a plurality of scan electrodes and a plurality of sustain electrodes;
a scan driver for setting directions of driving pulses supplied to at least one pair of scan electrodes of the plurality of scan electrodes to be different from each other; and
a sustain driver for setting directions of driving pulses supplied to at least one pair of sustain electrodes of the plurality of sustain electrodes to be different from each other.

2. The plasma display apparatus as claimed in claim 1, wherein the pair of scan electrodes and the pair of sustain electrodes are adjacent to each other among the same electrodes.

3. The plasma display apparatus as claimed in claim 1, wherein the pair of scan electrodes and the pair of sustain electrodes are not adjacent to each other among the same electrodes.

4. The plasma display apparatus as claimed in claim 1, wherein the driving pulses are sustain pulses supplied to the plurality of scan electrodes and sustain electrodes during a sustain period.

5. A plasma display apparatus comprising:
a PDP comprising a plurality of scan electrodes and a plurality of sustain electrodes;
a first scan driver that supplies a driving pulse to first electrode groups of the plurality of scan electrodes;
a second scan driver that supplies a driving pulse, which has a different direction from that of the driving pulse supplied to the first electrode groups, to the remaining second electrode groups other than the first electrode groups, of the plurality of scan electrodes;
a first sustain driver that supplies a driving pulse to first electrode groups of the plurality of sustain electrodes; and
a second sustain driver that supplies a driving pulse, which has a different direction from that of the driving pulse supplied to the first electrode groups, to the remaining second electrode groups other than the first electrode group, of the plurality of sustain electrodes.

6. The plasma display apparatus as claimed in claim 5, wherein the driving pulses are sustain pulses supplied to the plurality of scan electrodes and the plurality of sustain electrodes during a sustain period.

7. The plasma display apparatus as claimed in claim 5, wherein the number of electrodes belonging to the first electrode group and the number of electrodes belonging to the second electrode group are different from each other.

8. The plasma display apparatus as claimed in claim 5, wherein the number of electrodes belonging to the first electrode group and the number of electrodes belonging to the second electrode group are the same.

9. The plasma display apparatus as claimed in claim 5, wherein the first electrode groups of the plurality of scan electrodes are odd-numbered scan electrodes of the plurality of scan electrodes, and the first electrode groups of the plurality of sustain electrodes are odd-numbered sustain electrodes of the plurality of scan electrodes, and
the second electrode groups of the plurality of scan electrodes are even-numbered scan electrodes of the plurality of scan electrodes and the second electrode groups of the plurality of sustain electrodes are even-numbered sustain electrodes of the plurality of scan electrodes.

10. A plasma display apparatus comprising:
a PDP comprising a plurality of scan electrodes and a plurality of sustain electrodes;
a first scan driver formed on a longitudinal side of the PDP, for supplying a driving pulse to a first scan electrode group of the plurality of scan electrodes;
a first sustain driver formed adjacent to the first scan driver, for supplying a driving pulse to a first sustain electrode group of the plurality of sustain electrodes;
a second scan driver on a longitudinal side of the PDP, for supplying a driving pulse, which has a direction different from that of the driving pulse supplied to the first scan electrode group, to a second scan electrode group of the plurality of scan electrodes; and
a second sustain driver formed adjacent to the second scan driver, for supplying a driving pulse, which has a direction different from that of the driving pulse supplied to the first sustain electrode group, to a second sustain electrode group of the plurality of sustain electrodes.

11. The plasma display apparatus as claimed in claim 10, wherein the first scan driver and the first sustain driver are formed on an opposite side to the second scan driver and the second sustain driver on the basis of a central longitudinal axis of the PDP.

12. The plasma display apparatus as claimed in claim 10, wherein the driving pulses are sustain pulses supplied to the plurality of scan electrodes and the plurality of sustain electrodes during a sustain period.

13. A plasma display apparatus comprising:
a PDP comprising a plurality of scan electrodes and a plurality of sustain electrodes;
a first scan driver formed on a longitudinal side of the PDP, for supplying a driving pulse to odd-numbered scan electrodes of the plurality of scan electrodes;
a first sustain driver formed adjacent to the first scan driver, for supplying a driving pulse to odd-numbered sustain electrodes of the plurality of sustain electrodes;
a second scan driver formed on a longitudinal side of the PDP, for supplying a driving pulse, which has a direction different from that of the driving pulse supplied to the odd-numbered scan electrodes, to even-numbered scan electrodes of the plurality of scan electrodes; and
a second sustain driver formed adjacent to the second scan driver, for supplying a driving pulse, which has a direction different from that of the driving pulse supplied to the odd-numbered sustain electrodes, to even-numbered sustain electrodes of the plurality of sustain electrodes.

14. The plasma display apparatus as claimed in claim 13, wherein the first scan driver and the first sustain driver are formed on an opposite side to the second scan driver and the second sustain driver on the basis of a central longitudinal axis of the PDP.

15. A driving method of a plasma display apparatus that drives a PDP comprising a plurality of scan electrodes and a plurality of sustain electrodes, the driving method comprising the steps of:
while supplying a driving pulse to a first scan electrode group of the plurality of scan electrodes, supplying a driving pulse, which has a direction different from that of the driving pulse supplied to the first scan electrode group, to a second scan electrode group of the plurality of scan electrodes; and
while supplying a driving pulse to a first sustain electrode group of the plurality of sustain electrodes, supplying a driving pulse, which has a direction different from that of the driving pulse supplied to the first sustain electrode group, to a second sustain electrode group of the plurality of sustain electrodes.

16. The method as claimed in claim 15, wherein the driving pulses are sustain pulses supplied to the plurality of scan electrodes and sustain electrodes during a sustain period.

17. The method as claimed in claim 15, wherein the number of electrodes belonging to the first electrode group and the number of electrodes belonging to the second electrode group are different from each other.

18. The method as claimed in claim 15, wherein the number of electrodes belonging to the first electrode group and the number of electrodes belonging to the second electrode group are the same.

19. The method as claimed in claim 15, wherein the first electrode groups of the plurality of scan electrodes are odd-numbered scan electrodes of the plurality of scan electrodes, and the first electrode groups of the plurality of sustain electrodes are odd-numbered sustain electrodes of the plurality of scan electrodes, and
the second electrode groups of the plurality of scan electrodes are even-numbered scan electrodes of the plurality of scan electrodes and the second electrode groups of the plurality of sustain electrodes are even-numbered sustain electrodes of the plurality of scan electrodes.
